(19) United States
(12) Patent Application Publication
(10) Pub. No.: US 2007/0137440 A1
(43) Pub. Date: Jun. 21, 2007

(54) Socket provided with a ratchet device

(76) Inventor: Ting Hwang, Taichung (TW)

Correspondence Address: PRO-TECHTOR INTERNATIONAL SERVICES, 20775 NORADA CT., SARATOGA, CA, 95070, US

(21) Appl. No.: 11/312,048

(22) Filed: Dec. 19, 2005

(51) Int. Cl. B25B 13/00

(52) U.S. Cl. 81/59.1

(57) ABSTRACT

A socket provided with a ratchet device comprises: a polygon-shaped end portion, a ratchet device having a receiving groove provided with a plurality of retaining walls and guiding walls, a plurality of retaining members and springs, a direction-controlling sleeve having a plurality of protruded portions therebottom, and a coupling bar. At one end of the socket is formed the polygon-shaped end portion, while at another end is defined with the ratchet device. The receiving groove is formed at the upper end of socket for receiving a plurality of retaining members and springs therein. Furthermore, the direction-controlling sleeve is externally fitted into the receiving groove for locating the respective protruded portion thereof between the two retaining members, and one end of coupling bar inserts through a central hole of direction-controlling sleeve for being confined in the socket, while another end outwardly projects out of the socket, thereby enabling the ratchet device to be effectively disposed in the limited space of socket so that the user can operate the wrench tool in a force-exerting direction by using the coupling bar to pivotally couple to the handle of wrench tool, in such a manner that the operational angle of the handle of wrench tool can be adjusted in different conditions.

### BACKGROUND OF THE INVENTION

1. Field of the Invention

The present invention relates to a ratchet device which can be mounted in the limited space of socket, so as to adjust the operational angle of the handle of wrench tool in different conditions.

2. Description of the Prior Arts

In early days, conventional wrench tools, such as socket wrenches or open-end wrenches, were merely provided with a single operation function, but these wrench tools are unable to satisfy the users' requirement nowadays. To expand the usage of wrench tool, a conventional combination wrench 1 is disclosed in FIG. 1, in which, said combination wrench 1 comprises a handle 11, a box-end portion 12 having a ratchet device 14 and an open-end portion 13, wherein the box-end portion 12 is disposed at one end of handle 11, while the open-end portion 13 is mounted at another end. By using the ratchet device 14 of box-end portion 12, the user can change the operation direction in different conditions and return the wrench to the initial direction. Nevertheless, the box-end portion 12 and the handle 11 are formed at a fixed angle, the operation angle of combination wrench 1 will therefore be confined.

Referring to FIG. 2, an improved combination wrench 2 capable of adjusting operation angle comprises a handle 21, an open-end portion 22 and a socket-end portion 23, wherein the open-end portion 22 is disposed at one end of the handle 21, while the socket-end portion 23 is pivotally coupled to another end. When the user uses the combination wrench 2 to assemble or disassemble a sink, for example, the socket-end portion 23 can be fitted into a bolt of sink, and then by grasping the handle 21, the required operation angle can be adjusted. However, because without a ratchet device fixed in the socket-end portion 23, when the combination wrench 2 is driven by the socket-end portion 23, it is unable to change the operation direction in a force-saving manner.

Referring to FIG. 3, a conventional socket wrench 3 provided with a ratchet device comprises a socket 4, a handle 31, a wrench head 32, a noise-making ratchet device 33 and a bar 34. The wrench head 32 is fixed at the opposite end of handle 31, and the ratchet device 33 is mounted to the wrench head 32. The bar 34 of ratchet device 33 is couplingly fitted into the socket 4 in such a manner that the socket 4 can be applied to assemble or disassemble the bolts of sink. Moreover, the ratchet device 33 can provide with an operation option of force-exerting directions so as to drives the socket 4 to disassemble or assemble said bolts. Unfortunately, the socket 4 doesn't provided with a ratchet device, hence, it only can be applied in a socket wrench with a ratchet device. If the socket 4 is used in a socket wrench without a ratchet device, the socket wrench can merely provided with the force-exerting operation function of single direction. As a result, the handle 31 of socket wrench 3 is unable to be used to adjust the operation angle in different conditions.

The present invention has arisen to mitigate and/or obviate the afore-described disadvantages.

### SUMMARY OF THE INVENTION

The primary objective of the present invention is to provide a socket provided with a ratchet device, wherein at one end of the socket is formed a polygon-shaped end portion, while at another end is defined with the ratchet device having a receiving groove, said receiving groove is provided with a plurality of retaining walls and guiding walls and is formed at the upper end of socket for receiving a plurality of retaining members and springs therein. Furthermore, a direction-controlling sleeve having a plurality of protruded portions therebottom is externally fitted into the receiving groove for locating the respective protruded portion between the two retaining members, and one end of a coupling bar inserts through a central hole of direction-controlling sleeve for being confined in the socket, while another end outwardly projects out of the socket, thereby enabling the ratchet device to be effectively disposed in the limited space of socket so that the user can operate the wrench tool in an optional force-exerting direction.

The secondary objective of the present invention is to provide a socket provided with a ratchet device, wherein at a square-shaped end of the coupling bar of ratchet device is defined with an adjusting structure for coupling the coupling bar to a handle of wrench tool, so that the operational angle of the handle of wrench tool can be adjusted to assemble or disassemble the bolts in different conditions.

Another objective of the present invention is to provide a socket provided with a ratchet device, wherein at another end of the handle of wrench tool can formed different type of end portion, such as an open-end portion of combination wrench. Therefore, the multi-purpose for force-saving operation and angle adjustment of handle both can be achieved.

The present invention will become more obvious from the following description when taken in connection with the accompanying drawings, which show, for purpose of illustrations only, a preferred embodiment in accordance with the present invention.

### BRIEF DESCRIPTION OF THE DRAWINGS

FIG. 1 shows a respective view of a conventional combination wrench;

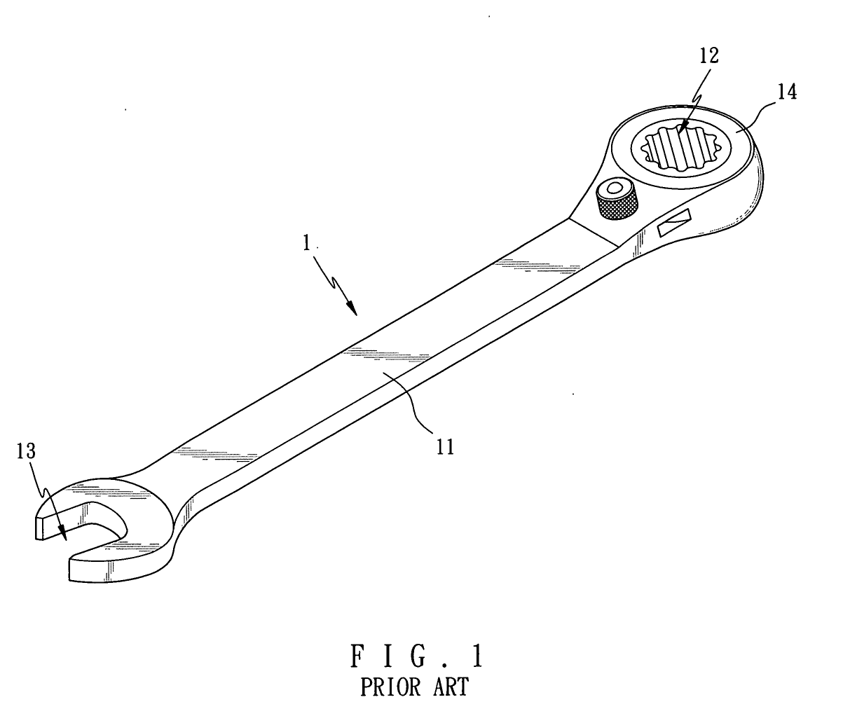

FIG. 2 shows a respective view of another conventional combination wrench;

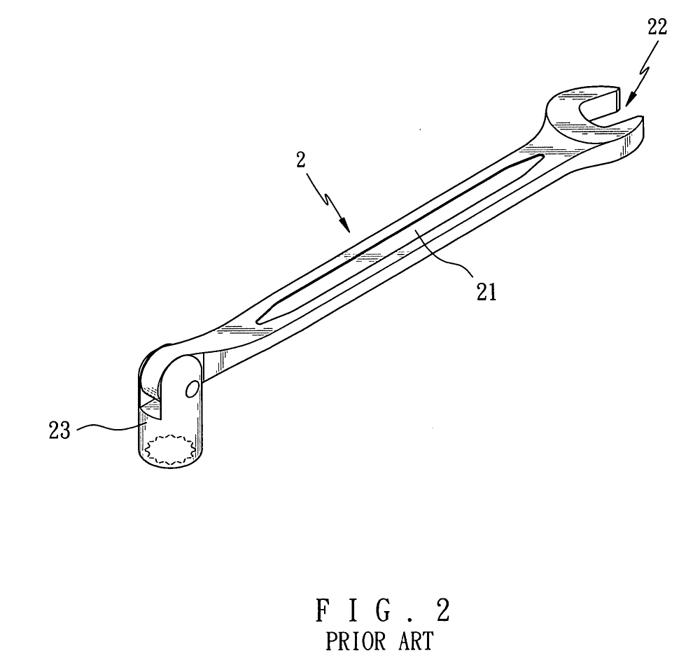

FIG. 3 is a respective view of a conventional socket wrench with a socket;

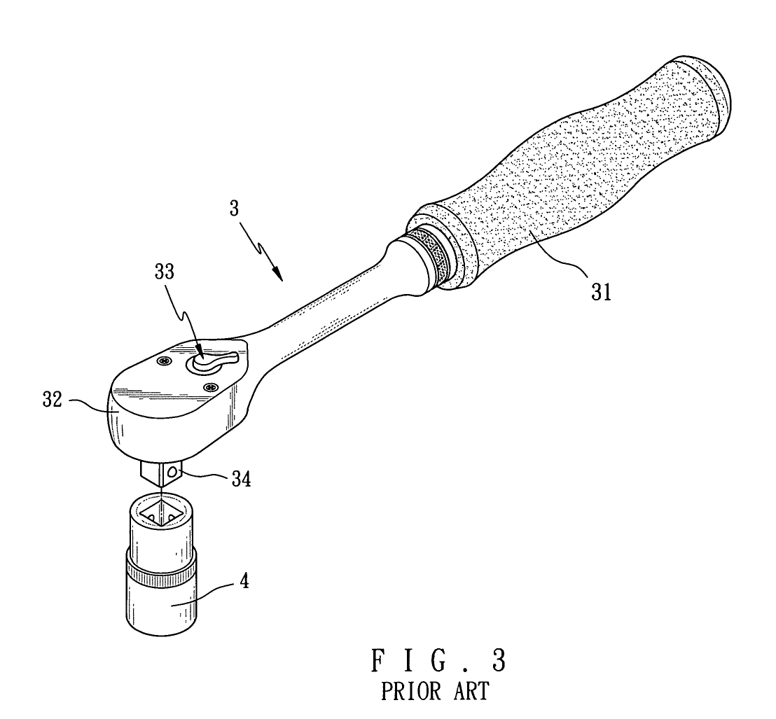

FIG. 4 is an exploded view of a socket provided with a ratchet device in accordance with the present invention;

FIG. 5 is a vertical cross-section view of a socket provided with a ratchet device in accordance with the present invention;

FIG. 6 is a horizontal cross-section view of a socket provided with a ratchet device in accordance with the present invention;

FIG. 7 is an operational cross-section view of a socket provided with a ratchet device in accordance with the present invention;

FIG. 8 is another operational cross-section view of a socket provided with a ratchet device in accordance with the present invention;

FIG. 9 is still another operational cross-section view of a socket provided with a ratchet device in accordance with the present invention;

FIG. 10 is an exploded view of a socket provided with a ratchet device in accordance with a first embodiment of the present invention;

FIG. 11 is an assembly view of a socket provided with a ratchet device in accordance with the first embodiment of the present invention;

FIG. 12 is an operational cross-section view of a socket provided with a ratchet device in accordance with the first embodiment of the present invention;

FIG. 13 is an assembly view of a socket provided with a ratchet device in accordance with a second embodiment of the present invention.

### DETAILED DESCRIPTION OF THE PREFERRED EMBODIMENT

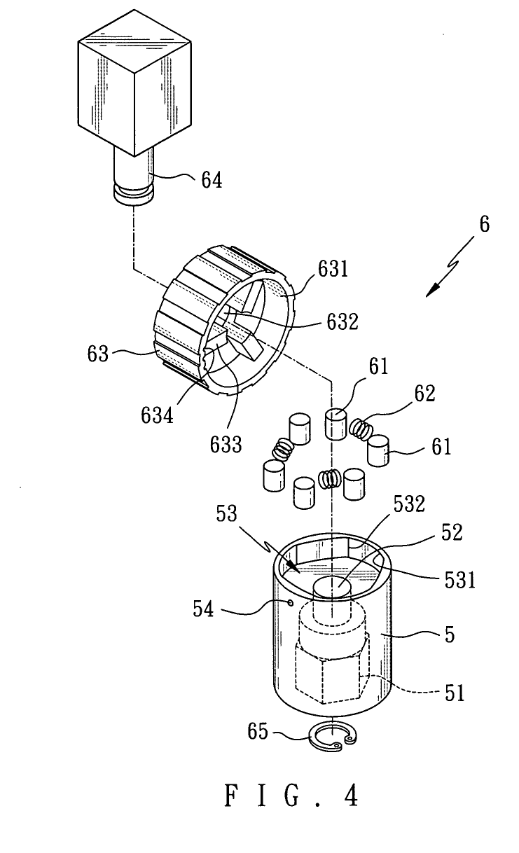

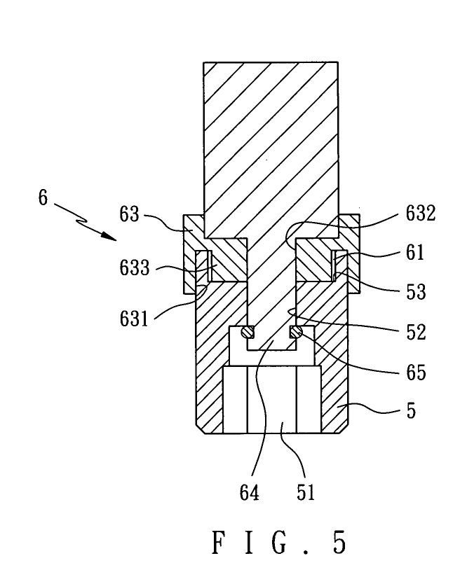

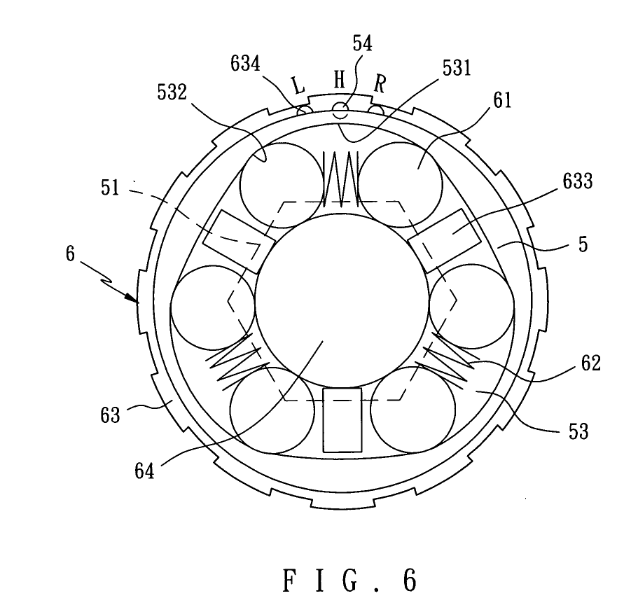

Referring to FIGS. 4-6, a socket provided with a ratchet device in accordance with the present invention is shown and comprises: a socket 5 of which one end is provided with a polygon-shaped end portion 51, and another end of socket 5 is defined with a ratchet device 6. The socket 5 is formed an aperture 52 therein and at upper end thereof is mounted a receiving groove 53. At the inner periphery of receiving groove 53 in response to the aperture 52 is disposed a plurality of guiding walls 531 having a larger surface, and at two sides of the respective guiding wall 531 are respectively arranged a retaining wall 532 having a gradually narrowed surface, thereafter, two cylinder-shaped retaining members 61 are put at the respective guiding wall 531, and between the two respective retaining members 61 is disposed an elastic element, such as a spring 62 for outwardly expanding two ends of spring 62 to respectively abut against the two retaining members 61 such that said two retaining members 61 can be retained at each side of the respective retaining wall 532. In addition, at a predetermined position of the outer surface of socket 5 is arranged a ball 54 for locating the socket 5, a direction-controlling sleeve 63 is provided with a fitting wall 631 at the lower end thereof, and a central hole 632 in response to the aperture 52 of socket 5 is formed in the direction-controlling sleeve 63. At the fitting wall 631 is projectedly fixed a plurality of protruded portions 633 respectively between the two respective retaining members 61, and a plurality of retaining recesses 634 are respectively arranged at a predetermined position of inner periphery of direction-controlling sleeve 63 corresponding to the ball 54 such that said direction-controlling sleeve 63 can be externally fitted into the receiving groove 53 of socket 5 by means of the fitting wall 631 thereof, and the respective protruded portion 633 can be positioned between one side of two respective retaining members 61, and by using one of the retaining recesses 634, the ball 54 can be located, so as to provide with a positioning option of middle, right or left direction. Moreover, one end of a coupling bar 64 inserts through the central hole 632 of direction-controlling sleeve 63 and then be located in the aperture 52 of socket 5 by using a C-shaped fastener 65, while another square-shaped end of coupling bar 64 projects out of the socket 5.

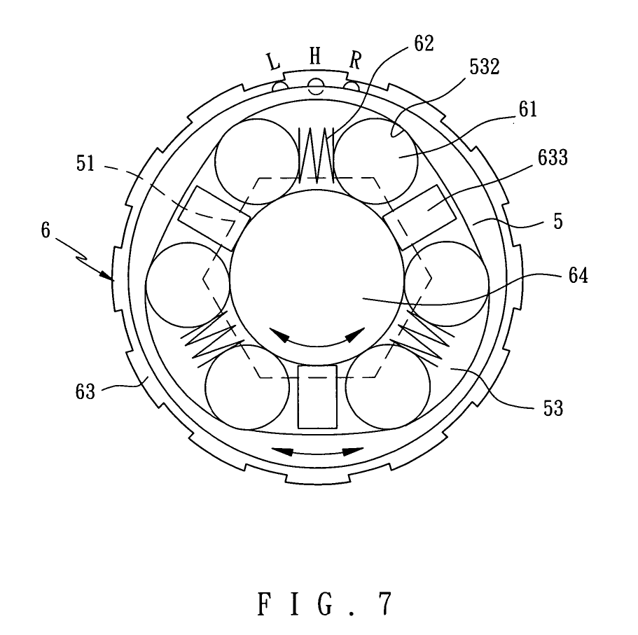

Referring to FIG. 7, the direction-controlling sleeve 63 of ratchet device 6 of socket 5 can be used to choose the operation force-exerting direction. For example, when the direction-controlling sleeve 63 is turned to the H controlling position of middle direction, the respective protruded portion 633 can't push against any retaining members 61, accordingly, the respective retaining member 61 will be urged by the respective spring 62 to outwardly retain at the respective retaining wall 532 and to abut against the coupling bar 64. Hence, when the coupling bar 64 rotates in a clockwise or an anti-clockwise direction, it will urge the respective retaining member 61 to simultaneously move, and by using the respective retaining member 61 to abut against the respective retaining wall 532 of receiving groove 53, the socket 5 will be pushed to turn in the same rotating direction as the coupling bar 64. As a result, the user can use the polygon-shaped end portion 51 of socket 5 to dissemble or assemble the bolts in different conditions.

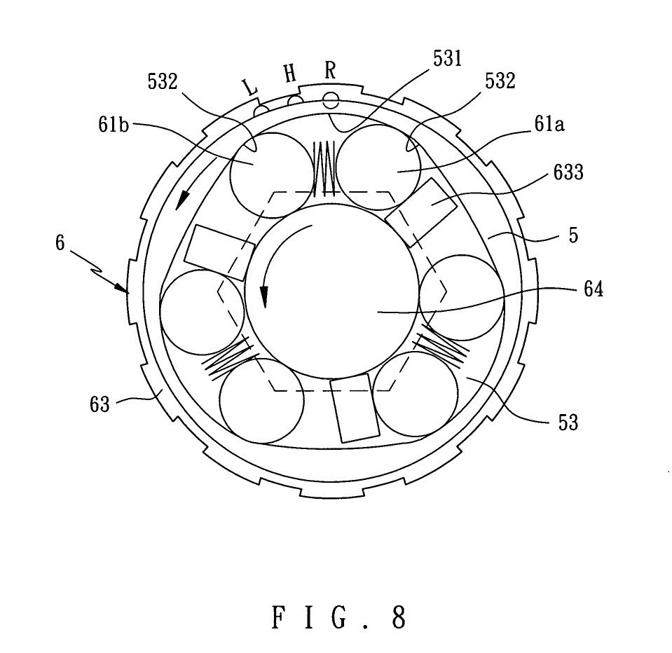

Referring to FIG. 8, when the direction-controlling sleeve 63 is turned to the R controlling position of right direction, the respective protruded portion 633 will leftwardly push against the respective retaining member 61a, accordingly, said retaining member 61a will inwardly return to disengage from the respective retaining wall 532 and move toward the respective guiding wall 531, at this time, another retaining member 61b will outwardly retain at the retaining wall 532, hence, when the coupling bar 64 rotates in the anti-clockwise direction, it will urge the retaining member 61b to simultaneously move, and by using said retaining member 61b to abut against the respective retaining wall 532 of receiving groove 53, the socket 5 can be driven by the retaining member 61b to rotate as the coupling bar 64. On the contrary, when the coupling bar 64 rotates in the clockwise direction, the retaining member 61a will inwardly return to the guiding wall 531 to disengage from the coupling bar 64, consequently, the coupling bar 64 will be idling.

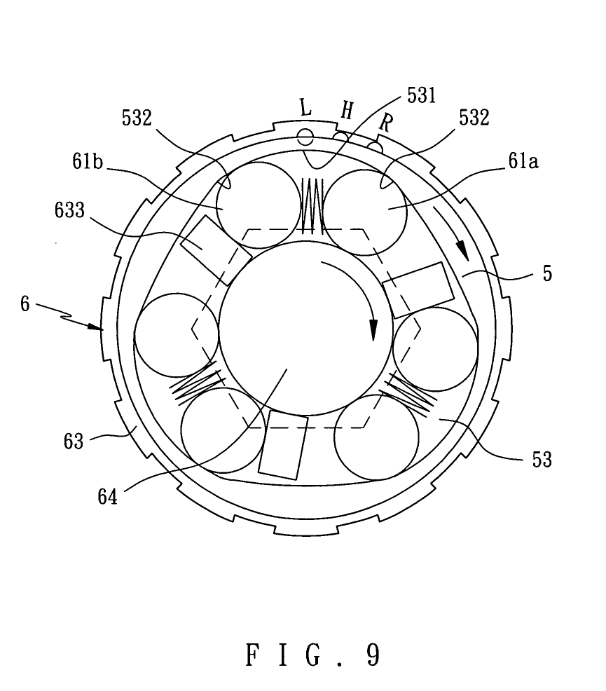

Referring to FIG. 9, when the direction-controlling sleeve 63 is turned to the L controlling position of left direction, the respective protruded portion 633 will rightwardly push against the respective retaining member 61b, accordingly, the retaining member 61b will inwardly return to disengage from the respective retaining wall 532 and move toward the respective guiding wall 531, at this time, another retaining member 61a can outwardly retain at the retaining wall 532, hence, when the coupling bar 64 rotates in the clockwise direction, it will urge the retaining member 61a to simultaneously move. On the contrary, when the coupling bar 64 rotates in the anti-clockwise direction, the retaining member 61b will inwardly return to the guiding wall 531 to disengage from the coupling bar 64, as a result, the coupling bar 64 will be idling.

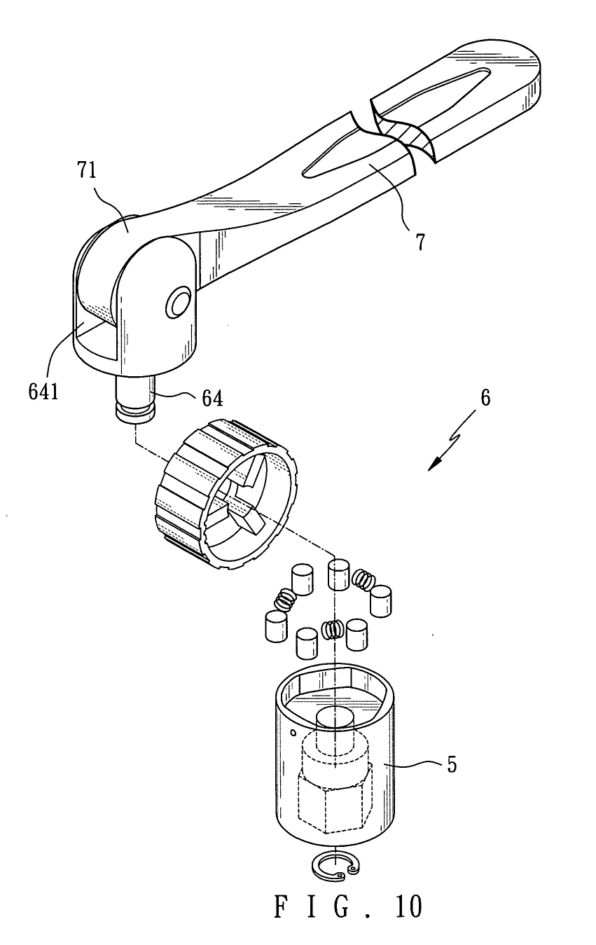

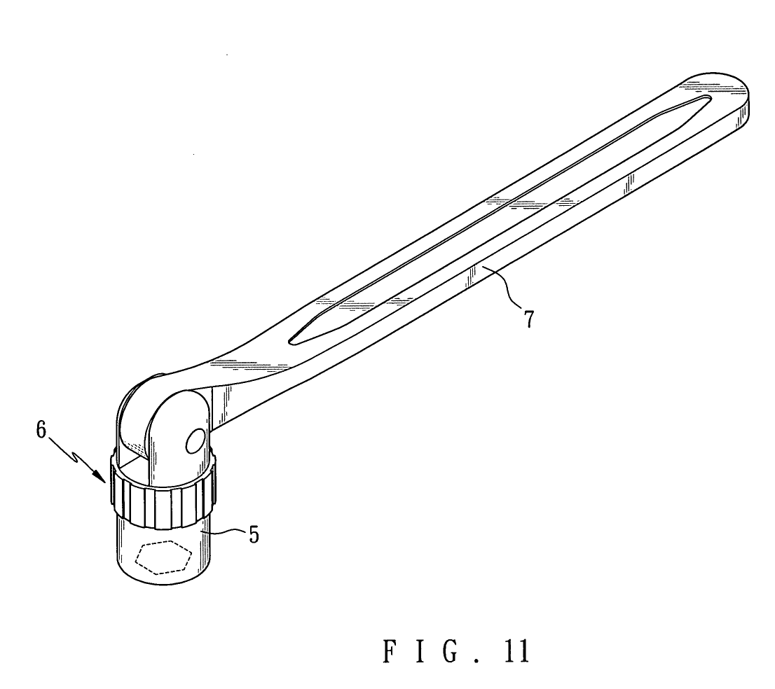

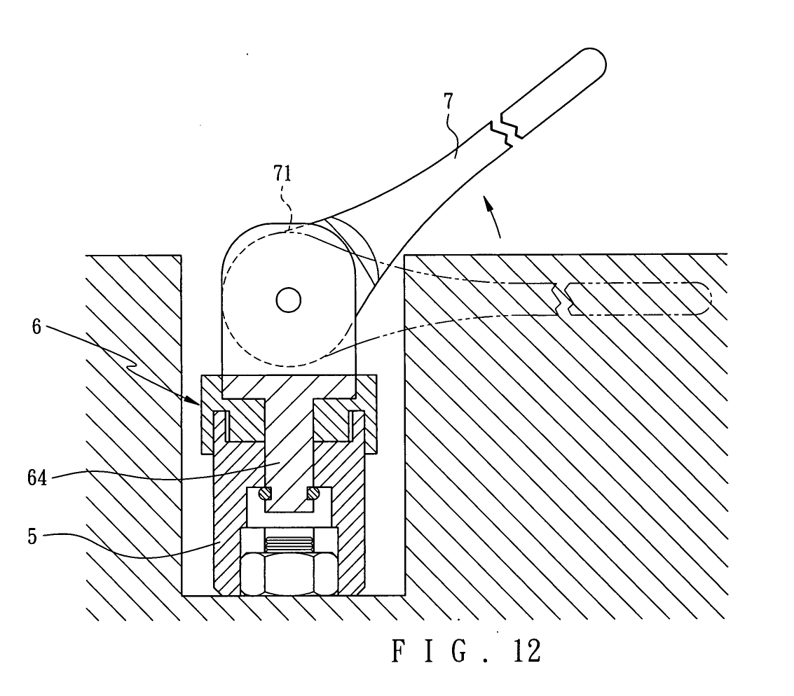

Referring further to FIGS. 10-12, a socket provided with a ratchet device in accordance with a first embodiment of the present invention is shown and comprises:

a socket 5 capable of being pivotally coupled to a handle 7 by using a coupling bar 64 of a ratchet device 6, and an adjusting structure defined between the coupling bar 64 and the handle 7. Aforesaid adjusting structure comprises a coupling portion 641 formed at the top end of coupling bar 64, a pin-connected end 71 arranged at one end of handle 7. By using a pin, the coupling portion 641 and the pin-connected end 71 can be pivotally inserted through and the handle 7 can be coupled to one end of coupling bar 64 as well, such that said handle 7 can drive the socket 5 to rotate by means of the ratchet device 6. Consequently, when a wrench is used to disassemble or assemble the bolts of a sink or the bolts on the surface having some barriers, by using the handle 7 and the adjusting structure, the pin-connected end 71 of handle 7 can pivotally rotate upward to a required angle, such as 45 degree, so as to control the operational angle of socket 5 by adjusting the handle 7 in different conditions, thereafter, by means of the ratchet device 6, the operational force-exerting direction 20 can be controlled to drive the socket 5 to disassemble or assemble the bolts.

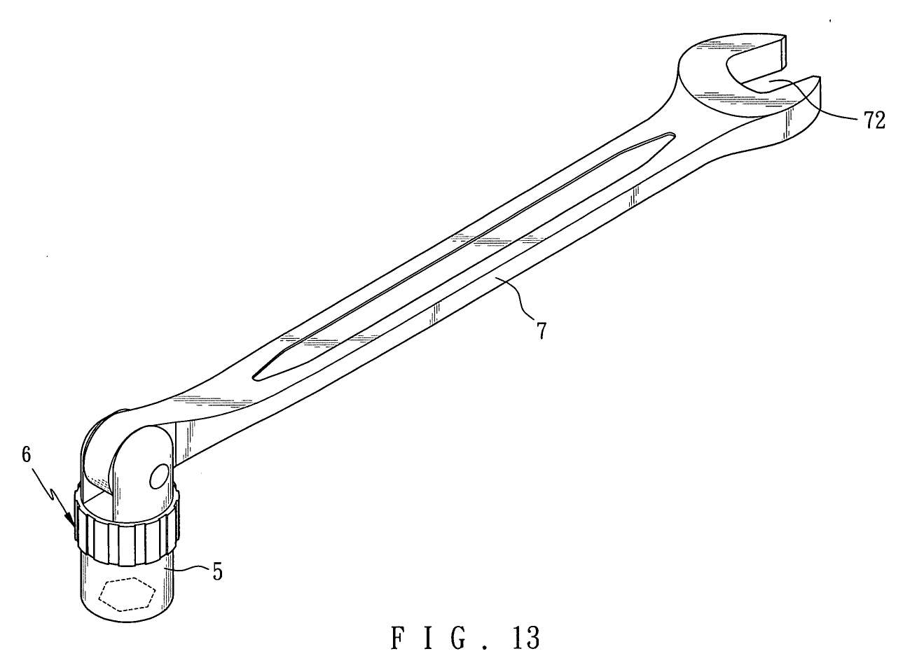

On the other hand, as shown in FIG. 13, a socket provided with a ratchet device in accordance with a second embodiment of the present invention comprises, a socket 5, a ratchet device 6 as well as a handle 7, wherein by using the ratchet device 6, the socket 5 can be pivotally coupled to the handle 7, and at another end of handle 7 can be mounted a different type of tool end portion, such as an open-end portion 72, so as to form a combination wrench.

While we have shown and described various embodiments in accordance with the present invention, it should be clear to those skilled in the art that further embodiments may be made without departing from the scope of the present invention.

What is claimed is:

1. A socket provided with a ratchet device comprising:
a polygon-shaped end portion being formed at one end of socket;
a ratchet device being defined at another end of socket;
a receiving groove having a plurality of guiding walls and retaining walls being arranged in said ratchet device;
a plurality of retaining members and springs being respectively arranged between the respective guiding wall and the respective retaining wall;
a direction-controlling sleeve having a plurality of protruded portions therebottom being externally fitted into the receiving groove for locating the respective protruded portion thereof between the two retaining members;
a coupling bar of which one end inserting through a central hole of direction-controlling sleeve for being confined in the socket, and another end of coupling bar outwardly projecting out of the socket; thereby enabling the ratchet device to provide with the option of operational force-exerting direction.

2. The socket provided with a ratchet device as claimed in claim 1, wherein at the inner periphery of receiving groove is disposed a plurality of guiding walls respectively having a larger surface and a plurality of retaining walls respectively having a gradually narrowed surface.

3. The socket provided with a ratchet device as claimed in claim 1, wherein the respective retaining member of ratchet device is in the shape of cylinder.

4. The socket provided with a ratchet device as claimed in claim 1, wherein a plurality of elastic elements of ratchet device are respectively a spring.

5. The socket provided with a ratchet device as claimed in claim 1, wherein at the fitting wall of direction-controlling sleeve of ratchet device is projectedly fixed a plurality of protruded portions.

6. The socket provided with a ratchet device as claimed in claim 1, wherein a positioning element is defined at a predetermined position of the outer surface of socket, and a plurality of retaining recesses are respectively arranged at a predetermined position of inner periphery of direction-controlling sleeve for locating the socket.

7. The socket provided with a ratchet device as claimed in claim 1, wherein a central hole in response to an aperture of socket is formed in the direction-controlling sleeve for inserting and locating the coupling bar in the socket by using a confinement element.

8. A socket provided with a ratchet device comprising:
a polygon-shaped end portion being formed at one end of socket;
a ratchet device being defined at another end of socket;
a receiving groove having a plurality of guiding walls and retaining walls being arranged in said ratchet device;
a plurality of retaining members and springs being respectively arranged between the respective guiding wall and the respective retaining wall;
a direction-controlling sleeve having a plurality of protruded portions therebottom being externally fitted into the receiving groove for locating the respective protruded portions thereof between the two retaining members;
a coupling bar of which one end inserting through a central hole of direction-controlling sleeve for being confined in the socket, and another end of coupling bar outwardly projecting out of the socket;
an adjusting structure for coupling the handle of tool wrench; thereby enabling the ratchet device to provide with the option of operational force-exerting direction, and the handle can pivotally rotate upward to a required angle, so as to control the operational angle of socket in different conditions.

9. The socket provided with a ratchet device as claimed in claim 8, wherein at the inner periphery of receiving groove is disposed a plurality of guiding walls respectively having a larger surface and a plurality of retaining walls respectively having a gradually narrowed surface.

10. The socket provided with a ratchet device as claimed in claim 8, wherein the respective retaining member of ratchet device is in the shape of cylinder.

11. The socket provided with a ratchet device as claimed in claim 8, wherein a plurality of elastic elements of ratchet device are respectively a spring.

12. The socket provided with a ratchet device as claimed in claim 8, wherein at the fitting wall of direction-controlling sleeve of ratchet device is projectedly fixed a plurality of protruded portions.

13. The socket provided with a ratchet device as claimed in claim 8, wherein a positioning element is defined at a predetermined position of the outer surface of socket, and a plurality of retaining recesses are respectively arranged at a predetermined position of inner periphery of direction-controlling sleeve for locating the socket.

14. The socket provided with a ratchet device as claimed in claim 8, wherein a central hole in response to an aperture of socket is formed in the direction-controlling sleeve for inserting and locating the coupling bar in the socket by using a confinement element.

15. The socket provided with a ratchet device as claimed in claim 8, wherein a coupling portion of adjusting structure is formed at the top end of coupling bar, and a pin-connected end is arranged at one end of handle, by using a pin, the coupling portion and the pin-connected end can be pivotally coupled together.

16. The socket provided with a ratchet device as claimed in claim 8, wherein at another end of handle can arrange a different type of tool end portion.
